(19) United States
(12) Patent Application Publication
(10) Pub. No.: US 2012/0127524 A1
(43) Pub. Date: May 24, 2012

(54) DEVICE MANAGEMENT SYSTEM, INFORMATION PROCESSING DEVICE, INFORMATION PROCESSING METHOD, AND RECORDING MEDIUM

(75) Inventor: Kenji HAGIWARA, Kanagawa (JP)

(73) Assignee: RICOH COMPANY, LTD., Tokyo (JP)

(21) Appl. No.: 13/299,490

(22) Filed: Nov. 18, 2011

(30) Foreign Application Priority Data
Nov. 24, 2010 (JP) 2010-261770
Aug. 3, 2011 (JP) 2011-170178

(51) Int. Cl. G06F 3/12

(52) U.S. Cl. 358/1.15

(57) ABSTRACT

In a device management system, device managers are connected to communication devices and connected to an information processing device. Each device manager includes an acquisition part to acquire the device information from a communication device, a first management part to set and record the device information in a first data storage part and manage the communication device, and a transmitting part to transmit the acquired device information to the information processing device. The information processing device includes a reception part to receive the device information from the device managers and a second management part to set and record the received device information in a second data storage part and manage the communication devices managed by the device managers in a unified manner.

### BACKGROUND OF THE INVENTION

1. Field of the Invention

The present disclosure relates to a device management system, an information processing device, an information processing method, and a recording medium.

2. Description of the Related Art

A device management system which acquires device information from communications devices having a communication function (management object devices), such as printers and MFPs (multifunction peripherals), and manages the management object devices is known.

For example, Japanese Laid-Open Patent Publication No. 2003-030068 discloses a system in which a device manager performs a network control program on the device. The device manager sends a request to a communication device through the SNMP (simple network management protocol) and acquires an operating status of the communication device from the communication device. The communication device returns its operating status to the device manager in response to the request through the SNMP.

Japanese Laid-Open Patent Publication No. 2005-181411 discloses a device management system in which an order for consumable articles of a communication device is forwarded.

However, the mechanism of the communication method according to the related art has been unable to respond to large-scale implementation of a device management system. For example, the device management system according to the related art is provided with a device manager installed in each of business offices (organization units) of the introduction company, and the device manager performs device management of the communication devices within a local-area network.

In recent years, globalization of business corporations is progressing, and, rather than performing device management on the basis of each business office, unified management covering domestic areas and overseas areas is desired. In such a unified management case, the number of the communication devices as the management object devices amounts to several thousands or several tens of thousands.

It is desired to provide a large-size device management system that is able to manage many communication devices in a global environment in a unified manner and provide a device management service for the communication devices.

### SUMMARY OF THE INVENTION

In one aspect, the present disclosure provides a device management system, an information processing device, an information processing method, and a recording medium which are capable of managing communication devices in a large-scale environment in a unified manner and providing a device management service for the communication devices.

In an embodiment which solves or reduces one or more of the above-described problems, the present disclosure provides a device management system which manages a plurality of communication devices, wherein the plurality of the communication devices are connected to a plurality of device managers respectively, the plurality of device managers are connected to an information processing device, and each communication device is connected to the information processing device via one of the plurality of device managers, each device manager including: a first data storage part to store device information of the communication device in a predetermined storage region; an acquisition part to acquire device information from the communication device; a first management part to set and record the acquired device information in the first data storage part and manage the communication device; and a transmitting part to transmit the acquired device information to the information processing device, and the information processing device including: a second data storage part to store the device information of the plurality of the communication devices in a predetermined storage region; a reception part to receive the device information from the plurality of device managers; and a second management part to set and record the received device information in the second data storage part and manage the plurality of the communication devices managed by the plurality of device managers in a unified manner.

Other objects, features and advantages of the present disclosure will become more apparent from the following detailed description when read in conjunction with the accompanying drawings.

### BRIEF DESCRIPTION OF THE DRAWINGS

FIG. 1 is a diagram showing the composition of a device management system of an embodiment of the present disclosure.

FIG. 2 is a diagram showing the hardware composition of a primary server (unified management device) of the present embodiment.

FIG. 3 is a diagram showing the functional composition of a primary server and a secondary server of the present embodiment.

FIG. 4 is a diagram showing an example of management data of the primary server of the present embodiment.

FIG. 5 is a diagram showing an example of management data of the secondary server of the present embodiment.

FIG. 6 is a sequence diagram for explaining a process of device information acquisition and management data setting/recording of the present embodiment.

FIG. 7 is a sequence diagram for explaining a process of external notification based on the notification condition in the primary server of the present embodiment.

FIG. 8 is a sequence diagram for explaining a process of external notification based on the notification condition in the primary server of the present embodiment.

FIG. 9 is a sequence diagram for explaining a process of external notification based on the notification condition in the primary server of the present embodiment.

FIG. 10 is a sequence diagram for explaining a process of external notification based on the notification condition in the secondary server of the present embodiment.

FIG. 11 is a sequence diagram for explaining a process of external notification based on the notification condition in the secondary server of the present embodiment.

### DETAILED DESCRIPTION OF THE PREFERRED EMBODIMENTS

A description will be given of embodiments of the present disclosure with reference to the accompanying drawings.

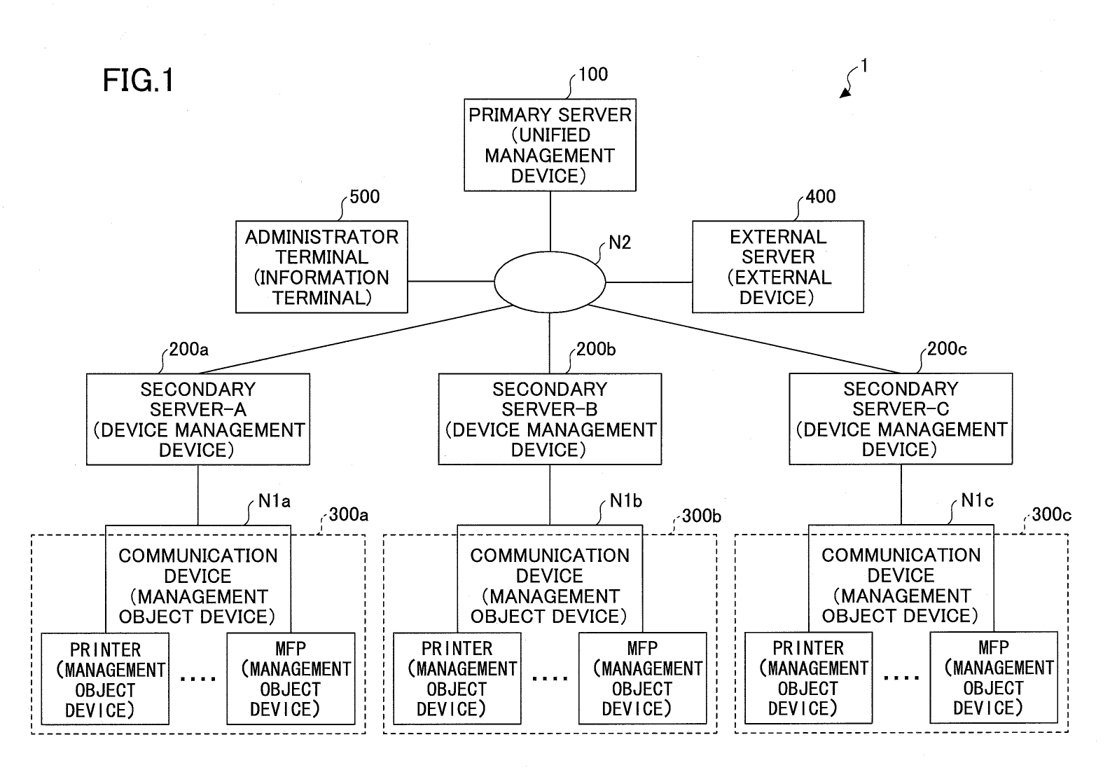

FIG. 1 is a diagram showing the composition of a device management system 1 of an embodiment of the present disclosure. As shown in FIG. 1, the device management system 1 of this embodiment is constructed to include a plurality of the communication devices 300a, 300b, 300c (which may also be called communication devices 300 collectively), and a plurality of secondary servers 200a, 200b, 200c (which may also be called secondary servers 200 collectively) to manage the communication devices 300, and the communication devices 300 and the secondary servers 200 are respectively connected by a plurality of transmission lines N1a, N1b, N1c (which may also be called internal networks N1 collectively), such as networks (e.g., LANs).

In this embodiment, each communication device 300 is an image forming device having a communication function, such as a printer and an MFP. On the other hand, each secondary server 200 is a device manager (information processing device) which acquires device information from the communication device 300 and performs device management of the communication device 300.

In the device management system 1 of FIG. 1, a primary server 100 which is provided to manage the plurality of the communication devices 300 in a unified manner, and the plurality of secondary servers 200 are connected together via a transmission line N2 (which may also be called an external network N2), such as a network (e.g., a WAN).

The primary server 100 is a unified management device (information processing device) which acquires the device information of the plurality of the communication devices 300, each of which is a management object, from the plurality of secondary servers 200, stores the acquired device information in a predetermined storage region of the memory, and manages the communication devices 300 in a unified manner.

In the device management system 1 of FIG. 1, an external server 400, an administrator terminal 500, etc. are also connected to the external network N2.

The external server 400 is an external device (information processing device) which receives the notification information from the secondary server 200 or the primary server 100 and performs predetermined information processing based on the received notification information. For example, the information processing performed by the external server 400 may include an ordering process of the consumable articles of the communication device 300.

The administrator terminal 500 is an information terminal (e.g., a PC (personal computer), a PDA (personal digital assistant), etc.) which receives the notification information from the secondary server 200 or the primary server 100 and presents to an administrator the received notification information. The information presenting method by the administrator terminal 500 may include screen displaying, sound reproduction, etc.

As described above, in this embodiment, the device management system 1 is constructed so that the communication devices 300 are connected to the primary server 100 through the secondary servers 200 by the above-described system composition, and the device management system 1 can provide a device management service for the communication devices 300 in a large-scale environment in a unified manner.

Next, the hardware composition of the primary server 100 of this embodiment will be described.

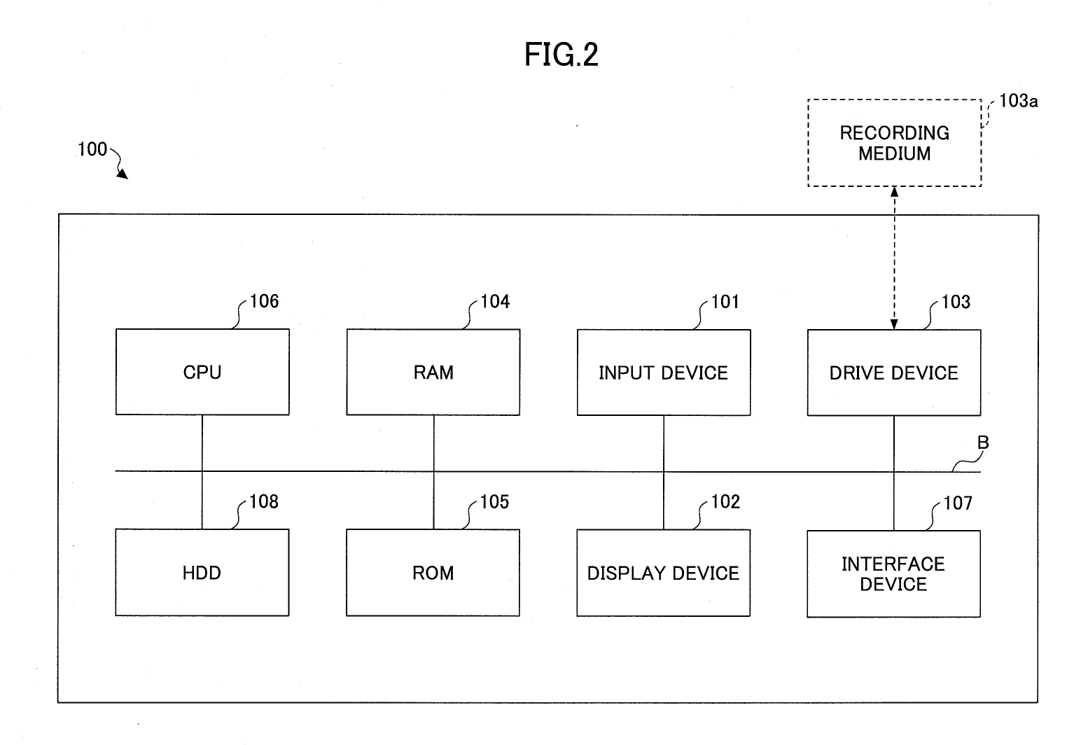

FIG. 2 is a diagram showing the hardware composition of a primary server 100 (unified management device) of this embodiment.

As shown in FIG. 2, the primary server 100 is constructed to include an input device 101, a display device 102, a drive device 103, a RAM (random access memory) 104, a ROM (read only memory) 105, a CPU (central processing unit) 106, an interface device 107, and a HDD (hard disk drive) 108. These devices in the primary server 100 are interconnected by a bus B.

The input device 101 includes a keyboard, a mouse, etc. which are provided to input each operational signal to the primary server 100. The display device 102 includes a display, etc. which is provided to display the processed result from the primary server 100.

The interface device 107 provides an interface which connects the primary server 100 to the transmission line N2. By using the interface device 107, the primary server 100 can perform data communication with the secondary server 200, the external server 400, the administrator terminal 500, etc. via the transmission line N2.

The HDD 108 is a nonvolatile storage which stores programs and data in the primary server 100. The programs and data stored in the HDD 108 include the OS (operating system), such as Windows or UNIX, as the basic software to control the whole primary server 100, and application programs executed on the operating system to provide various functions. In the HDD 108, the programs and data stored therein are managed by a predetermined file system and/or a predetermined database system.

The drive device 103 provides an interface between the primary server 100 and with a removable recording medium 103a which is detachably attached to the primary server 100. By using the drive device 103, the primary server 100 can perform reading/writing of information from/to the recording medium 103a. Examples of the recording medium 103a may include a floppy disk, a CD (compact disk), a DVD (digital versatile disk), an SD (secure digital) memory card, a USB (universal serial bus) memory, etc.

The ROM 105 is a nonvolatile semiconductor memory (storage) which can store internal data even when the power is turned off. The programs and data of BIOS (basic input/output system), information-processing-system setting, network setting, etc. which are executed upon starting of the primary server 100 are stored in the ROM 105. The RAM 104 is a volatile semiconductor memory (memory) which stores programs and data temporarily. The CPU 106 is a processor unit which controls the whole device and performs the installed functions by reading a program and data from the above storage (HDD or ROM), loading the same on the RAM (memory), and executing the program thereon.

By using the above-described hardware composition, the primary server 100 of this embodiment can provide various information processing services for the communication devices 300.

As is apparent from FIG. 2, the hardware composition of the primary server 100 is basically the same as the hardware composition of a general-purpose information processing device. Similarly, each of the secondary server 200, the external server 400, and the administrator terminal 500 has the hardware composition which is the same as the above-described hardware composition of the primary server 100, and can be constructed by using the functional composition of a general-purpose information processing device in the same manner.

The information processing function of this embodiment will be described.

In the device management system 1 of this embodiment, the plurality of the communication devices 300 and the plurality of secondary server 200 (device managers) to manage the communication devices 300 are connected via the plurality of internal networks N1 respectively, and the plurality of secondary servers 200 and the primary server 100 (unified management device) are connected together via the external network N2, so that the primary server 100 manages the communication devices 300 managed by the secondary servers 200 in a unified manner. Each communication device 300 is connected to the primary server 100 via the corresponding one of the secondary servers 200.

In the device management system 1 of this embodiment, the secondary server 200 acquires device information from the communication device 300, stores the acquired device information in the predetermined storage region of the secondary server 200 to manage the communication device 300, and transmits the acquired device information to the primary server 100. After the device information of the plurality of the communication devices 300 is received from the plurality of secondary servers 200, the primary server 100 stores the received device information in the predetermined storage region of the primary server 100, and manages the plurality of the communication devices 300 managed by the plurality of secondary servers 200 in a unified manner. The device management system 1 of this embodiment has such an information processing function.

Regarding the device management system of this type, with globalization of the introduction company, it is desired to provide a large-size device management system which is able to provide a device management service for many communication devices 300 in a global environment in a unified manner.

The device management system 1 of this embodiment is constructed so that each communication device 300 is connected to the primary server 100 via the corresponding one of the secondary servers 200. Hence, the device management system 1 of this embodiment is able to provide a device management service for many communication devices 300 in a global environment in a unified manner.

It is necessary to take the following points into consideration for such a large-size device management system 1. For example, when an error or an obstacle takes place in the communication device 300 which is a management object in the device management system 1, the secondary server 200 has a function to transmit an error notification to the administrator. This function is common to the plurality of secondary servers 200, and it is conceivable that this function is implemented in the primary server 100 in a concentrated manner.

However, if the function is implemented in the primary server 100, a time lag in the notification arriving at the administrator will occur. Especially, when the load of the communication between the secondary server 200 and the primary server 100 is heavy, reception of the error notification by the primary server 100 will be delayed from reception of the device information of the communication device 300 corresponding to the error or obstacle in the communication device 300 by the secondary server 200. When an obstacle in the communication between the secondary server 200 and the primary server 100 takes place, the primary server 100 is unable to receive the device information of the corresponding communication device 300 from the secondary server 200, and is unable to receive the error notification of the communication device 300 also in this case.

To eliminate the problem, in the device management system 1 of this embodiment, the process to transmit a notification outside by the communication device 300 is divided into sub-processes according to the kind of notification information, and the sub-processes are distributed to the primary server 100 and the secondary server 200 in a suitable manner.

Next, the composition and its operation of the primary server 100 and the secondary server 200 of this embodiment will be described.

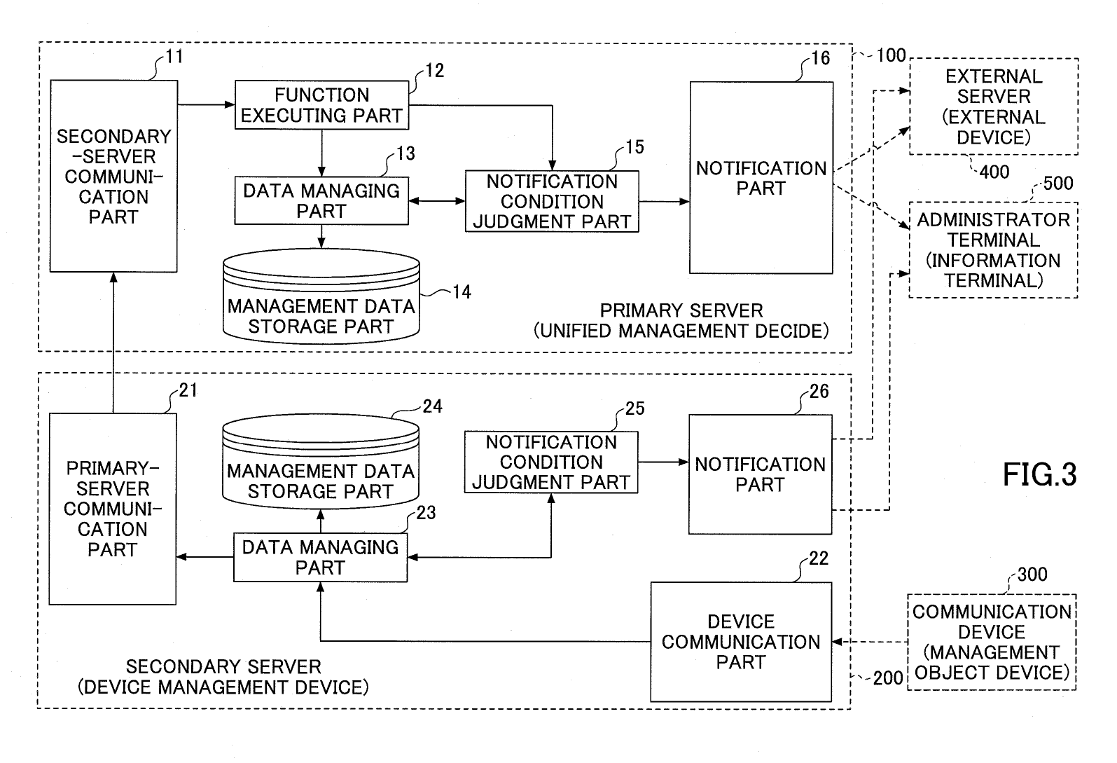

FIG. 3 is a diagram showing the composition of the primary server 100 and the secondary server 200 of this embodiment. As shown in FIG. 3, the primary server 100 of this embodiment is constructed to include a secondary-server communication part 11, a function executing part 12, a data managing part 13, a management data storage part 14, a notification condition judgment part 15, and a notification part 16. The secondary server 200 of this embodiment is constructed to include a primary-server communication part 21, a device communication part 22, a data managing part 23, a management data storage part 24, a notification condition judgment part 25, and a notification part 26.

In the primary server 100, the secondary-server communication part 11 is a function part which performs data communication with the secondary server 200. The secondary-server communication part 11 receives the device information of the communication device 300 from the secondary server 200.

The function executing part 12 is a function part which performs the presenting function provided in the primary server 100. The presenting function provided in the primary server 100 may include a management function of the device information of the communication device 300, a notification function, etc. The function executing part 12 is a function part performed by the application program mounted in the primary server 100. When the reception data (the device information of the communication device) is received from the secondary-server communication part 11, the function executing part 12 sends a request for setting/recording of the received data (storing of the received data as management data) to the data managing part 13.

The data management part 13 is a function part which performs predetermined data manipulation according to the request, and manages the management data which is the device information of the communication device 300 set and recorded. The data management part 13 accesses the management data storage part 14 which stores the management data, and performs the requested data manipulation to the corresponding data (in the corresponding storage region). The management data storage part 14 corresponds to the predetermined storage region of the storage (HDD) provided in the primary server 100.

Next, the management data stored in the management data storage part 14 will be described.

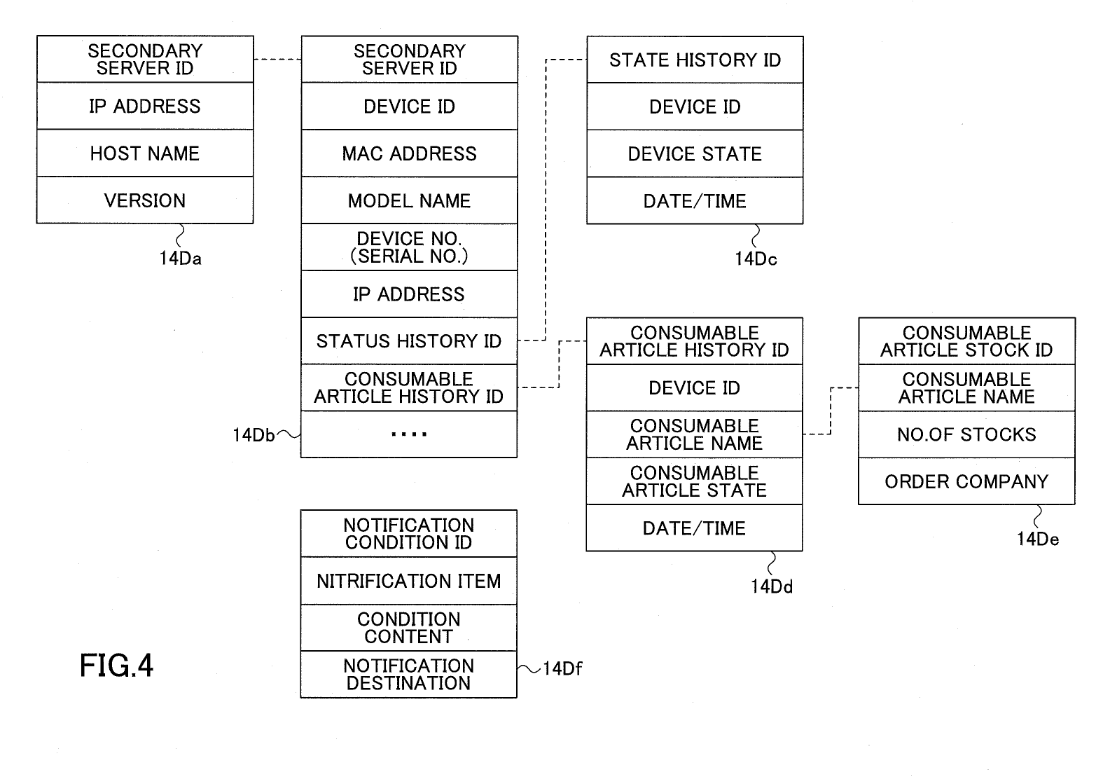

FIG. 4 is a diagram showing the example of management data of the primary server 100 of this embodiment. As shown in FIG. 4, in the primary server 100, secondary server information 14Da, device management information 14Db, state history information 14Dc, consumable article history information 14Dd, consumable article stock information 14De, and notification condition information 14Df, are stored as management data.

### (a) Secondary Server Information

The secondary server information 14Da is the setup information concerning the secondary server 200, which contains information items, such as a secondary server ID, an IP address (Internet Protocol address), a host name and a version, which are associated with each other, and the secondary server information 14Da is managed per server.

The secondary server ID item is an item to which the identification information (secondary server identification information) of the secondary server 200 is set. The IP address item is an item to which the IP address information assigned to the secondary server 200 is set. The host name item is an item to which the information (device name information) indicating the device name of the secondary server 200 is set. The version item is an item to which the version information of the software mounted in the secondary server 200 (installation) is set.

The value of each information item of the secondary server information 14Da is set up by the data managing part 13 based on the input by the administrator through the setting GUI (graphical user interface) of the management function provided by the function executing part 12. Alternatively, the data management part 13 may be configured to set up the item value of the secondary server information 14Da based on the server information received from the secondary server 200. In this case, if the function executing part 12 receives an automatic setting command from the administrator through the setting GUI, the secondary-server communication part 11 detects the secondary server 200 by broad/multicast signaling. Thereby, the secondary server communication part 11 requests the detected secondary server 200 to forward the server information, and the data managing part 13 sets up the item value based on the server information received from the secondary server 200. At this time, the ID value assigned for each server is set to the item value of the secondary server identification information.

The server information is periodically received by the secondary-server communication part 11 from the secondary server 200, and a data setting/recording request is output from the function executing part 12, so that the secondary server information 14Da is updated to the newest information by the data managing part 13.

### (b) Device Management Information

The device management information 14Db is the setup information concerning the communication device 300 which is a management object. The device management information 14Db contains information items, such as a secondary server ID, a device ID, a MAC address, a model name, a device number (serial number), an IP address, a status history ID and a consumable article history ID, which are associated with each other, and the device management information 14Db is managed per device.

The secondary server ID item is an item to which the secondary server identification information for managing the communication device 300 is set. The device ID item is an item to which the identification information (communication device identification information) of the communication device 300 is set. The MAC (media access control) address item is an item to which the MAC address information uniquely assigned to the network I/F (not illustrated) provided in the communication device 300 is set. The model name item is an item to which the model name information of the communication device 300 is set. The device number (serial number) item is an item to which the product control information assigned to the communication device 300 is set. The IP address item is an item to which the IP address information assigned to the communication device 300 is set. The status history ID item is an item to which the identification information (state history identification information) of the state history information 14Dc corresponding to the communication device 300 is set. The consumable article history ID item is an item to which the identification information (consumable article history identification information) of the consumable article history information 14Dd corresponding to the communication device 300 is set.

The value of each information item of the device management information 14Db is set up by the data managing part 13 based on the device information of the communication device 300 received from the secondary server 200. The ID value assigned for each communication device 300 is set to the item value of the device identification information. The plurality of ID values assigned for respective device state or consumable article record data (state history/consumable article history) are set to the respective item values of the status history identification information and the consumable article history identification information. The device information of the communication device 300 is received by the secondary-server communication part 11, and a data setting/recording request is output from the function executing part 12, so that the device management information 14Db is updated to the newest information by the data managing part 13.

### (c) State History Information

The state history information 14Dc is the information concerning the device state of the communication device 300, containing information items, such as a state history ID, a device ID, a device state and a date/time, which are associated with each other and the state history information 14Dc is managed per history of a device state.

The state history information 14Dc contains state history identification information, which is associated with the device management information 14Db. The device state item is an item in which the device state information of the communication device 300 is recorded, and the item value is a service call value (SC number), an error value, etc. accompanied with an error or an obstacle occurring on the device. The date/time item is an item in which the recording date of the state history information 14Dc is recorded.

The value of each information item of the status history information 14Dc is recorded by the data managing part 13 based on the device state information contained in the device information of the communication device 300 received from the secondary server 200. The ID value assigned for each device state record data (state history) is set to the item value of the status history identification information.

The device information of the communication device 300 is received by the secondary-server communication part 11 and a data setting/recording request is output from the function executing part 12, so that new information for the state history information 14Dc is generated by the data managing part 13.

### (d) Consumable Article History Information

The consumable article history information 14Dd is the information concerning the consumable articles provided in the communication device 300, containing information items, such as a consumable article history ID, a device ID, a consumable article name, a consumable article state and a date/time, which are associated with each other, and the consumable article history information 14Dd is managed per history of a consumption state.

The consumable article history information 14Dd contains the consumable article history identification information, which is associated with the device management information 14Db. The consumable article name item is an item in which the consumable article name information is recorded, and the item value may include a medium tray name, a toner cartridge name, etc., when the communication device 300 is a printer. The consumable article state item is an item in which the consumable article state information of the consumable articles is recorded, and the item value may include a recording sheet residual quantity, a toner/ink residual quantity, an accumulated rotational frequency (counter value) of a photoconductor, etc. The date/time item is an item in which the recording date of the consumable article history information 14Dd is recorded.

The value of each information item of the consumable article history information 14Dd is recorded by the data managing part 13 based on the consumable article state information contained in the device information of the communication device 300 received from the secondary server 200. The ID value assigned for each consumption state record data (the consumable article history) is set to the item value of the consumable article history identification information.

The device information of the communication device 300 is received by the secondary-server communication part 11 and a data setting/recording request is output from the function executing part 12, so that new information for the consumable article history information 14Dd is generated by the data managing part 13.

### (e) Consumable Article Stock Information

The consumable article stock information 14De is the information concerning the stock of consumable articles, containing information items, such as a consumable article stock ID, a consumable article name, the number of stocks, and an order company, which are associated with each other and the consumable article stock information 14De is managed for each consumable article.

The consumable article stock information 14De contains the consumable article name information, which is associated with the consumable article history information 14Dd. The consumable article stock ID item is an item to which the identification information (stock identification information) of the consumable article stock is set. The consumable article name item is an item to which the consumable article name information is set. The number of stocks item is an item to which the number-of-stocks information of the consumable articles is set. The order company item is an item to which the order destination information of the consumable articles is set. The item value of the order company is a supplier's e-mail address, a fax number, etc.

The value of each information item of the consumable article stock information 14De is set up by the data managing part 13 based on the input from the administrator through the setting GUI of the management function provided by the function executing part 12.

### (f) Notification Condition Information

The notification condition information 14Df is the information concerning the notification condition to be followed when the primary server 100 transmits a notification outside. The notification condition information 14Df contains information items, such as a notification condition ID, a notification item, the content of the condition and a notification destination, which are associated with each other, and the notification condition information 14Df is managed per notification condition.

The notification condition ID item is an item to which the identification information (notification condition identification information) of the notification condition is set. The notification-item item is an item to which the notification name information is set, and the item value is a toner (color: X), a recording sheet (size: X), occurrence of a service call (SC: X), occurrence of an error (classification: X), etc. The content-of-condition item is an item to which the definition information of the notification condition (notification condition definition information) is set, and the item value is “occurrence frequency of the same error >=3 times a month”, “the number of times of exchange of the consumable article >=3 times a month”, etc. The notification destination item is an item to which the notification destination information is set, and the item value is an e-mail address of the external server 400, an e-mail address of the administrator terminal 500, etc.

The value of each information item of the notification condition information 14Df is set up by the data managing part 13 based on the input from the administrator through the setting GUI of the management function provided by the function executing part 12.

In the case of the primary server 100, even if a time lag exists in transmitting a notification outside, the notification condition for notifying the information which does not affect the quality of service is set to the item value of the notification condition definition information. As is apparent from the above-described notification condition, the notification information is statistical information in a low level of urgency (the accuracy is not needed).

As described above, if the data managing part 13 receives a data setting/recording request from the function executing part 12, the data managing part 13 accesses the management data storage part 14 and stores the input by the administrator received in response to the request, the device information of the communication device 300, or the server information of the secondary server 200 in the storage region, so that the stored information is set and recorded as the management data.

The data management part 13 also performs various data operations of data reference (acquisition), data deletion (elimination), updating (overwrite), etc. besides the data setting/recording, according to the request from other function parts.

Referring back to FIG. 3, the notification condition judgment part 15 is a function part which determines whether the predetermined notification condition is satisfied according to the request. The notification condition judgment part 15 refers to the notification condition information 14Df received from the data managing part 13 according to the request, and specifies the notification condition. The notification condition judgment part 15 refers to information used for judgment through the data managing part 13 based on the specified notification condition, and determines whether the notification condition is satisfied based on the information. The notification condition judgment part 15 requests the notification part 16 to transmit the notification when the notification condition is satisfied.

The notification part 16 is a function part which transmits a notification outside according to the request. The notification part 16 generates notification information and transmits the generated notification information to the external server 400 and/or the administrator terminal 500 based on the notification destination information received from the notification condition judgment part 15 according to the request. The notification part 16 generates the notification information containing a judgment result of the notification condition.

In the secondary server 200, the primary-server communication part 21 is a function part which performs data communication with the primary server 100. The primary-server communication part 21 transmits the device information of the communication device 300 acquired by the secondary server 200, to the primary server 100. In the primary-server communication part 21, it transmits based on the IP address information assigned to the primary server 100 set up beforehand, for example.

The device communication part 22 is a function part which performs data communication with the communication device 300 which is a management object. The device communication part 22 acquires the device information from the communication device 300. In this case, the device communication part 22 detects the communication device 300 as the management object by broad/multicast signaling according to the predetermined timing. Thereby, the device communication part 22 requests the detected communication device 300 to transmit the device information, and acquires the device information from the communication device 300. The predetermined timing is the timing at which the predetermined time measured using the internal clock provided in the secondary server 200 has elapsed.

After the device information is acquired from the communication device 300, the device communication part 22 requests the communication device 300 to transmit the device information to the primary-server communication part 21, and requests the data managing part 23 to perform setting/recording of the device information (stored as management data).

The data management part 23 is a function part which performs predetermined data manipulation according to the request, and manages the management data which is the device information of the communication device 300 set and recorded. The data management part 23 accesses the management data storage part 24 which stores the management data, and performs a requested data manipulation to the corresponding data (or the corresponding storage region). The management data storage part 24 corresponds to the predetermined storage region of the storage (HDD) provided in the secondary server 200.

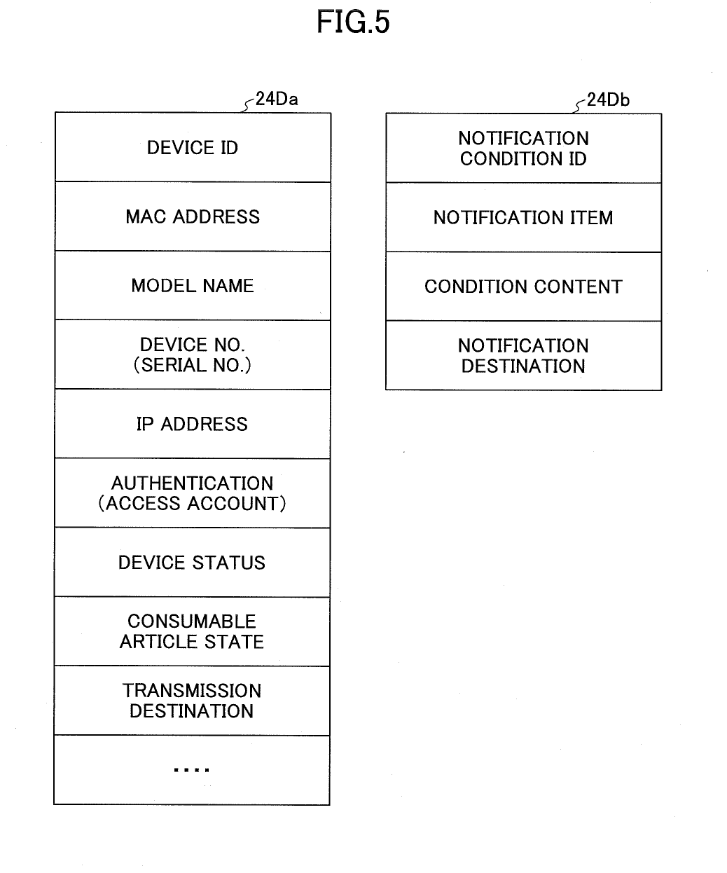

Next, the management data stored in the management data storage part 24 will be described. FIG. 5 is a diagram showing an example of the management data of the secondary server 200 of this embodiment.

As shown in FIG. 5, in the secondary server 200, device management information 24Da and notification condition information 24Db are stored as management data.

### (a) Device Management Information

The device management information 24Da is the setup information concerning the communication device 300 which is a management object, and the device management information 24Da contains information items, such as a device ID, a MAC Address, a model name, a device number (serial number), an IP address, an authentication (access account), a device state, a consumption state, and a transmission destination, which are associated with each other, and this information is managed per device.

The information items, including the device ID, the MAC address, the model name, the device number and the IP address, in the device management information 24Da are the same as the corresponding information items of the device management information 14Db stored in the primary server 100, and a description thereof will be omitted.

The authentication (access account) item is an item to which the certification information used at the time of accessing the communication device 300 is set. The device state item is an item in which the device state information of the communication device 300 is recorded, and the item value includes the newest device state value and the previous device state value. The consumable article state item is an item in which the consumable article state information of the consumable articles is recorded, and the item value includes the newest state value and the previous state value. The transmission destination item is an item to which the transmission destination information of the device information is set, and the item value is an IP address, a URI (uniform resource identifier), etc. which are assigned to the primary server 100.

The value of each information item of the device management information 24Da is set up by the data managing part 23 based on the device information received from the communication device 300. The device information is received by the device communication part 22 and a data setting/recording request is output so that the device management information 24Da is updated to the newest information by the data managing part 23.

### (b) Notification Condition Information

The notification condition information 24Db is the information concerning the notification condition to be followed when the secondary server 200 transmits a notification outside. The notification condition information 24Db contains information items, such as a notification condition ID, a notification item, the content of the condition, and a notification destination, which are associated with each other, and the notification condition information 24Db is managed per notification condition.

The above-described information items of the notification condition information 24Db are the same as the corresponding information items of the notification condition information 14Df stored in the primary server 100, and a description thereof will be omitted.

The value of each information item of the notification condition information 24Db is set up by the data managing part 23 based on the input from the administrator through the setting GUI of the management function. In the case of the secondary server 200, the item value of the notification condition definition information is set to, for example, “change to service call (SC) occurrence state”, “consumable article residual quantity is changed to near end state”, etc. Namely, in the secondary server 200, if a time lag exists in transmitting a notification outside, the notification condition for notifying the information which affects the quality of service is set up. As is apparent from the above-described notification condition, the notification information is error information or fault information with a high level of urgency (the accuracy is needed).

Referring back to FIG. 3, the notification condition judgment part 25 is a function part which determines whether the predetermined notification condition is satisfied according to the request. The notification part 26 is a function part which transmits a notification to the external server 400 or the administrator terminal 500 which is a notification destination according to the request.

The notification condition judgment part 25 and the notification part 26 provided in the secondary server 200 are the same as the notification condition judgment part 15 and the notification part 16 provided in the primary server 100, and a description thereof will be omitted.

As described above, in the system environment in which the communication device 300 is connected to the primary server 100 through the corresponding secondary server 200, the information processing function of this embodiment is performed when coordinated operations between the primary server 100 and the secondary server 200 are performed by the above-described function parts. In the device management system 1 of this embodiment, different notification conditions may be set up in the notification condition information 14Df stored in the primary server 100 and the notification condition information 24Db stored in the secondary server 200, the processing which transmits the information concerning the communication device 300 outside is divided according to the kind of the notification information, and distributed processing is carried out by the primary server 100 and the secondary server 200. The kinds of notification information may include the information with a low level of urgency, such as statistical information, and the information with a high level of urgency, such as error information, fault information, etc.

The information processing function of this embodiment may be performed by a program (software to perform the information processing function) mounted in each device of the device management system 1 which is read from the memory (RAM) of each device and executed by the processor unit (CPU) as in the following.

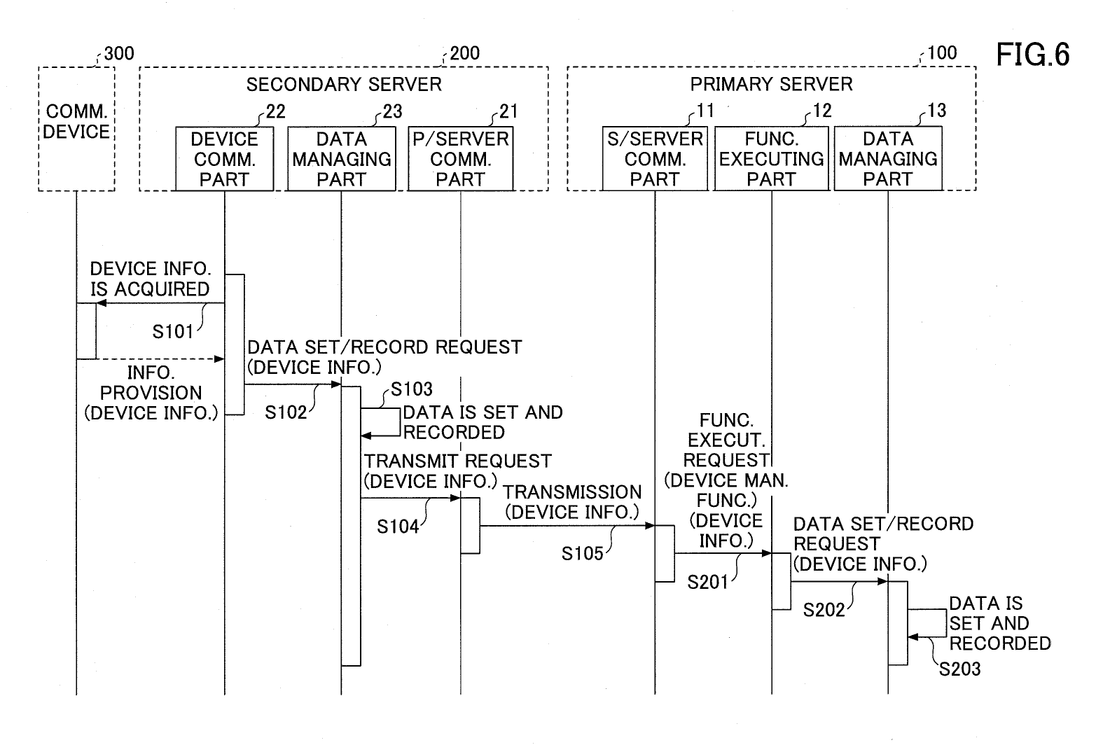

Next, FIG. 6 is a sequence diagram for explaining a process of device information acquisition and management data setting/recording of this embodiment.

As shown in FIG. 6, the secondary server 200 acquires the device information from the communication device 300 which is a management object by the device communication part 22 according to the predetermined timing (step S101).

After the device information is acquired, the device communication part 22 sends the device information to the data managing part 23, and sends a request for data setting/recording to the data managing part 23 (step S102).

In the secondary server 200, the data managing part 23 sets and records the device information of the communication device 300 as management data according to the data setting/recording request (step S103).

At this time, the management data storage part 24 is accessed by the data managing part 23 and the requested data setting/recording is performed to the corresponding data (or the corresponding storage region).

Subsequently, the secondary server 200 passes the device information to the primary-server communication part 21 by using the data managing part 23, and requests the primary-server communication part 21 to transmit the device information (step S104).

As a result, the secondary server 200 transmits the device information of the communication device 300 to the primary server 100 by using the primary-server communication part 21 (step S105). At this time, the primary-server communication part 21 transmits the device information based on the IP address information assigned to the primary server 100.

On the other hand, after the device information of the communication device 300 is received from the secondary server 200 by using the secondary-server communication part 11, the primary server 100 passes the device information to the function executing part 12 and requests the device management function (step S201).

After the device information of the communication device 300 is received, the function executing part 12 sends the device information to the data managing part 13 and requests the data managing part 13 to perform the data setting/recording (step S202).

The primary server 100 performs setting/recording of the device information of the communication device 300 as management data by using the data managing part 13 (step S203). At this time, the management data storage part 14 is accessed by the data managing part 13, and the requested data setting/recording of the corresponding data (or the corresponding storage region) is performed.

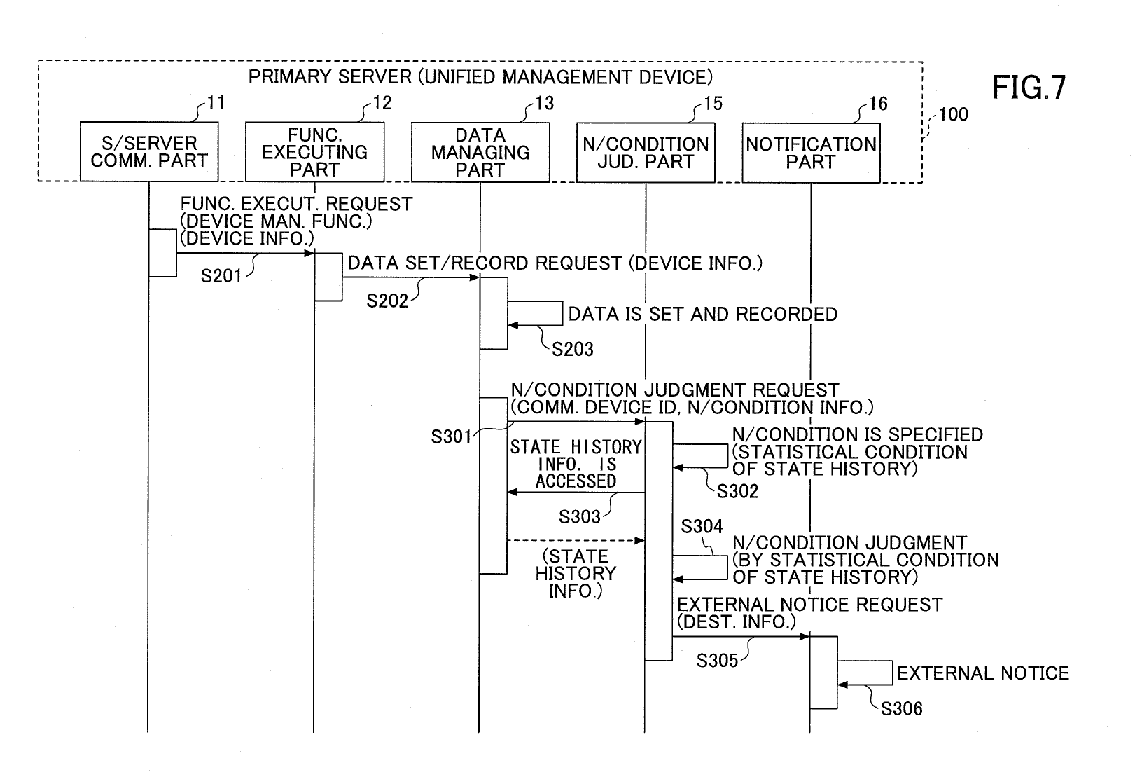

Next, FIG. 7 is a sequence diagram for explaining a process of external notification based on the notification condition in the primary server 100 of this embodiment.

The steps after step S203 shown in FIG. 6 are shown in FIG. 7, and further the process when the judgment condition by statistics of a device status history is set up as a notification condition is shown.

As shown in FIG. 7, after the setting/recording of the device information is done by the data managing part 13 by using the device information of the communication device 300 as management data, the primary server 100 passes the communication device identification information and the notification condition information 14Df to the notification condition judgment part 15 and requests the judgment of the notification condition (step S301).

At this time, the data managing part 13 passes the communication device identification information acquired from the device information of the communication device 300 and the notification condition information 14Df acquired from the management data storage part 14D to the notification condition judgment part 15.

As a result, the primary server 100 performs the process of notification condition judgment based on the predetermined notification condition by using the notification condition judgment part 15.

For example, when “occurrence frequency of the same error >=3 times a month” used for judgment according to statistics of a device state history is set in the notification condition information 14Df as notification condition definition information, the notification condition judgment part 15 performs the process of notification condition judgment as follows.

After the communication device identification information and the notification condition information 14Df are received from the data managing part 13, the notification condition judgment part 15 specifies that the notification condition to be applied is the “occurrence frequency of the same error >=3 times a month” by referring to the notification condition information 14Df (step S302).

Next, the notification condition judgment part 15 refers to the device management information 14Db based on the communication device identification information through the data managing part 13 and refers to the state history information 14Dc needed for judgment based on the state history identification information set in the device management information 14Db (step S303).

Next, the notification condition judgment part 15 determines whether the occurrence frequency of the same error is 3 times or more per month based on the record data of the state history information 14Dc referred to (step S304).

As a result, when the notification condition judgment part 15 determines that the notification condition is satisfied (when the occurrence frequency of the same error is 3 times or more per month), the primary server 100 passes the notification destination information to the notification part 16 and requests transmission of the notification (step S305). At this time, the notification condition judgment part 15 passes the notification destination information acquired from the notification condition information 14Df to the notification part 16.

The primary server 100 transmits a notification based on the notification destination information by using the notification part 16 (step S306). At this time, the notification part 16 generates notification information containing the judgment result of the notification condition, and transmits the generated notification information to the external server 400 and/or the administrator terminal 500 which are specified as the notification destination information.

In the case of the above-described notification condition, the notification information containing the information (statistical information) indicating that the occurrence frequency of the same error is 3 times or more per month, and the corresponding communication device 300 are generated and transmitted.

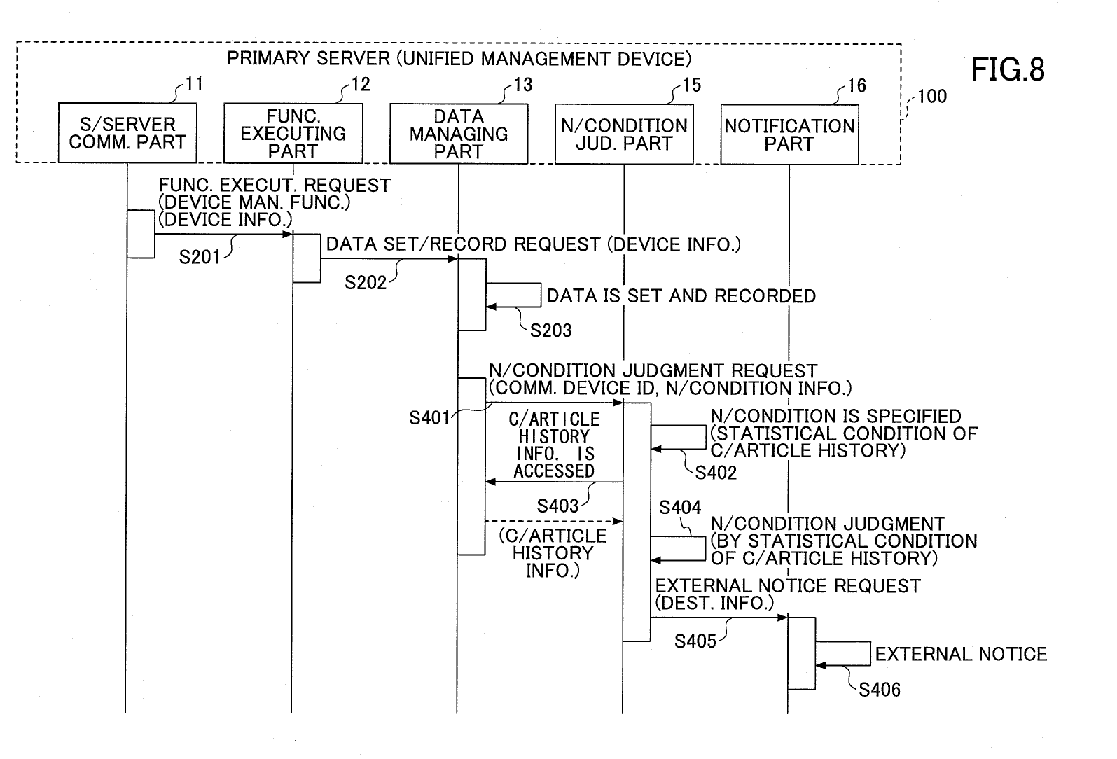

Next, FIG. 8 is a sequence diagram for explaining a process of external notification based on the notification condition in the primary server 100 of this embodiment. FIG. 8 shows the process of external notification when a judgment condition by statistics of a consumable article history is set up as a notification condition. In the following, only the different points from the process of FIG. 7 will be described.

As shown in FIG. 8, the primary server 100 performs the process of notification condition judgment based on the predetermined notification condition by using the notification condition judgment part 15.

For example, when “the number of times of exchange of a consumable article >=3 times a month” used for judgment according to statistics of a consumable article history is set in the notification condition information 14Df as notification condition definition information, the notification condition judgment part 15 performs the process of notification condition judgment as follows.

After the communication device identification information and the notification condition information 14Df are received from the data managing part 13, the notification condition judgment part 15 specifies that the notification condition to be applied is “the number of times of exchange of a consumable article >=3 times a month” by referring to the notification condition information 14Df (step S402).

Next, the notification condition judgment part 15 refers to the device management information 14Db based on the communication device identification information through the data managing part 13 and refers to the consumable article history information 14Dd needed for judgment based on the consumable article history identification information set in the device management information 14Db (step S403).

Next, the notification condition judgment part 15 determines whether the number of times of exchange of the consumable article is 3 times or more per month based on the record data of the consumable article history information 14Dd referred to (step S404).

As a result, when the notification condition judgment part 15 determines that the notification condition is satisfied (when the number of times of exchange is 3 times or more per month), the primary server 100 passes the notification destination information to the notification part 16 and requests transmission of the notification (step S405).

The primary server 100 transmits a notification based on the notification destination information by using the notification part 16 (step S406). In the case of the above-described notification condition, the notification information containing the information (statistical information) indicating that the number of times of exchange of the consumable article is 3 times or more per month, and the corresponding communication device 300 are generated and transmitted.

In the foregoing, the notification processing of the primary server 100 has been explained. However, when a plurality of different notification conditions are set, the process of external notification is performed for each notification condition. In this case, the plurality of notification condition information pieces 14Df are stored, the primary server 100 is arranged to perform the judgment of the notification condition based on each notification condition information piece 14Df and perform the process external notification based on the judgment result.

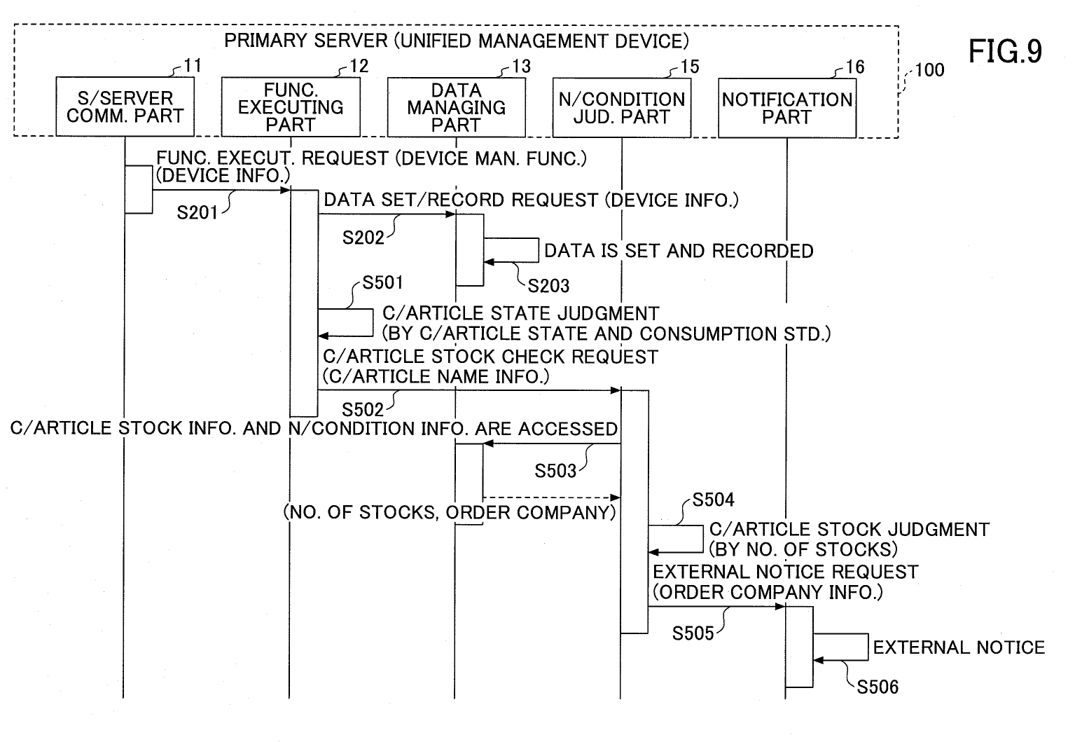

FIG. 9 is a sequence diagram for explaining a process of external notification based on the notification condition in the primary server 100 of this embodiment.

The steps after step S203 shown in FIG. 6 are shown in FIG. 9, and further the process when a judgment condition by a consumable article stock is set up as a notification condition is shown in FIG. 9.

As shown in FIG. 9, the primary server 100 determines whether the consumption state of the consumable article of the communication device 300 has reached a predetermined consumption standard level based on the consumable article state information, by using the function executing part 12 (step S501). The consumable article state information is contained in the device information of the communication device 300 received by the secondary-server communication part 11.

The function executing part 12 performs the process of judgment of the consumption state of the consumable article as follows.

For example, when the consumable article is a recording sheet, the function executing part 12 determines whether the sheet tray residual quantity (unit: % or number of sheets) as the consumable article state information is below a predetermined standard residual quantity. When the consumable article is a toner cartridge, the function executing part 12 determines whether the toner residual quantity (unit: %) as the consumable article state information is below a predetermined standard residual quantity. When the consumable article is a photoconductor, the function executing part 12 determines whether the accumulated rotational frequency (unit: rotation) as the consumable article state information is above a predetermined standard rotational frequency.

When the function executing part 12 determines that the consumption state of the consumable article has reached the consumption standard level, the primary server 100 passes the consumable article name information to the notification condition judgment part 15 and requests the checking of the consumable article stock (step S502). At this time, the function executing part 12 passes the consumable article name information, contained in the device information of the communication device 300 received by the secondary-server communication part 11, to the notification condition judgment part 15.

As a result, the primary server 100 performs the process of notification condition judgment based on the predetermined notification condition by using the notification condition judgment part 15.

For example, when “the number of stocks=0” used for judgment according to the stock condition of the consumable articles is set in the notification condition information 14Df as notification condition definition information, the process of notification condition judgment is performed as follows.

After the consumable article name information is received from the function executing part 12, the notification condition judgment part 15 refers to the consumable article stock information 14De through the data managing part 13 and refers to the number of stocks information needed for judgment (step S503).

Next, the notification condition judgment part 15 determines whether the number of stocks is equal to 0 based on the number of stocks information referred to (step S504).

As a result, when the notification condition judgment part 15 determines that the notification condition is satisfied (when the number of stocks is equal to 0), the primary server 100 passes the order destination information to the notification part 16 and requests transmission of the notification (step S505). At this time, the notification condition judgment part 15 passes the order destination information acquired from the consumable article stock information 14De to the notification part 16.

The primary server 100 transmits a notification outside based on the order destination information by using the notification part 16 (step S606). At this time, the notification part 16 generates the notification information containing the ordering information and transmits the generated notification information to the supply contractor specified in the order destination information.

In the case of the above-described notification condition, the notification information containing the name and the number of orders of the consumable articles checked and requested by the function executing part 13 is generated and transmitted.

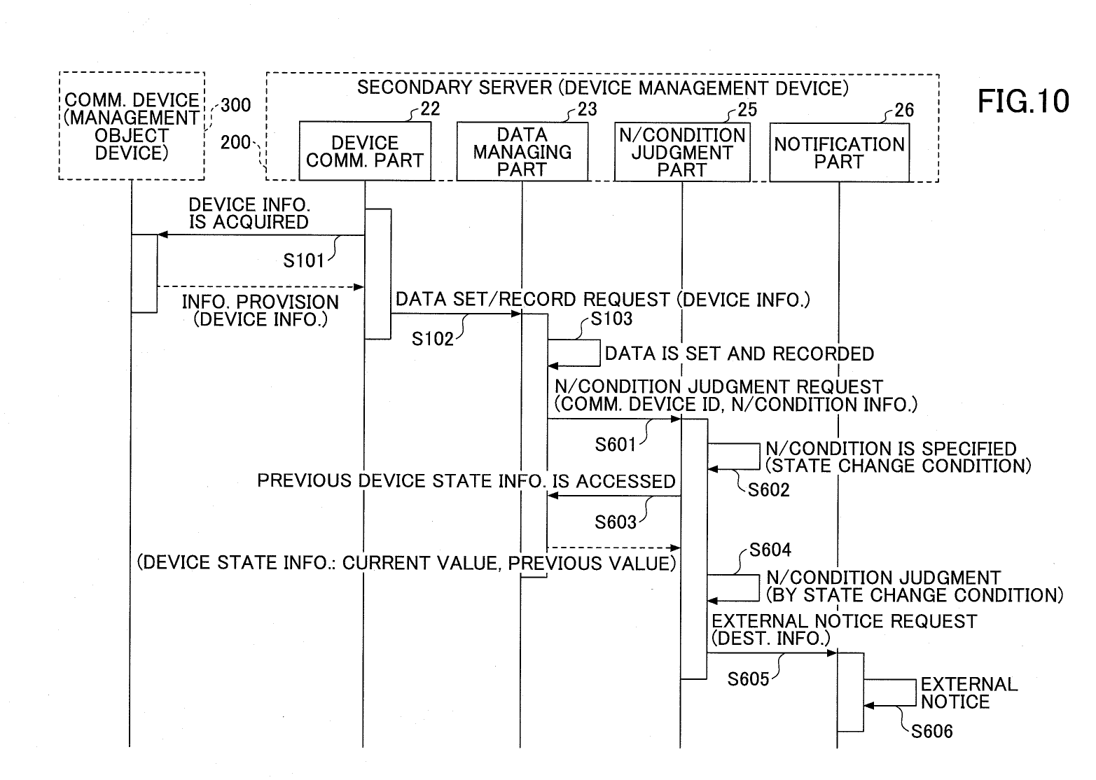

Next, FIG. 10 is a sequence diagram for explaining a process of external notification based on the notification condition in the secondary server 200 of this embodiment.

The steps after step S104 shown in FIG. 6 are shown in FIG. 10, and further the process when a judgment condition by a device state change is set up as a notification condition is shown in FIG. 10.

As shown in FIG. 10, after a request for transmission of the device information of the communication device 300 to the primary server 100 is sent to the primary-server communication part 21, the secondary server 200 causes the data managing part 23 to pass the communication device identification information and the notification condition information 24Db to the notification condition judgment part 25, and to request the judgment of the notification condition (step S601).

At this time, the data managing part 23 passes the communication device identification information acquired from the device information of the communication device 300 and the notification condition information 24Db acquired from the management data storage part 24D to the notification condition judgment part 25.

As a result, the secondary server 200 performs the process of notification condition judgment based on the notification condition, by using the notification condition judgment part 25.

For example, when “change to service call (SC) occurrence” used for judgment according to a device state change is set in the notification condition information 24Db as notification condition definition information, the notification condition judgment part 25 performs the process of notification condition judgment as follows.

After the communication device identification information and the notification condition information 24Db are received from the data managing part 23, the notification condition judgment part 25 refers to the notification condition information 24Db and specifies that the notification condition to be applied is the “change to service call (SC) occurrence” state (step S602).

Next, the notification condition judgment part 25 refers to the device management information 24Da based on the communication device identification information through the data managing part 23, and refers to the newest device state value and the previous (second newest) device state value of the device state information which are recorded in the device management information 24Da (step S603).

Next, the notification condition judgment part 25 determines whether the device state has changed to the service call (SC) occurrence state based on the newest device state value and the previous device state value (step S604).

As a result, when the notification condition judgment part 25 determines that the notification condition is satisfied (when the device state has changed to the service call (SC) occurrence state), the secondary server 200 passes the notification destination information to the notification part 26 and requests transmission of the notification (step S605). At this time, the notification condition judgment part 25 passes the notification destination information acquired from the notification condition information 24Db to the notification part 26.

The secondary server 200 transmits the notification outside based on the notification destination information by using the notification part 26 (step S606). At this time, the notification part 26 generates the notification information containing the judgment result of the notification condition, and transmits the generated notification information to the external server 400 and/or the administrator terminal 500 which are specified in the notification destination information.

In the case of the above-described notification condition, the notification information which includes the failure information indicating that the device state has changed to the service call (SC) occurrence state, and the information concerning the corresponding communication device 300 are generated and transmitted.

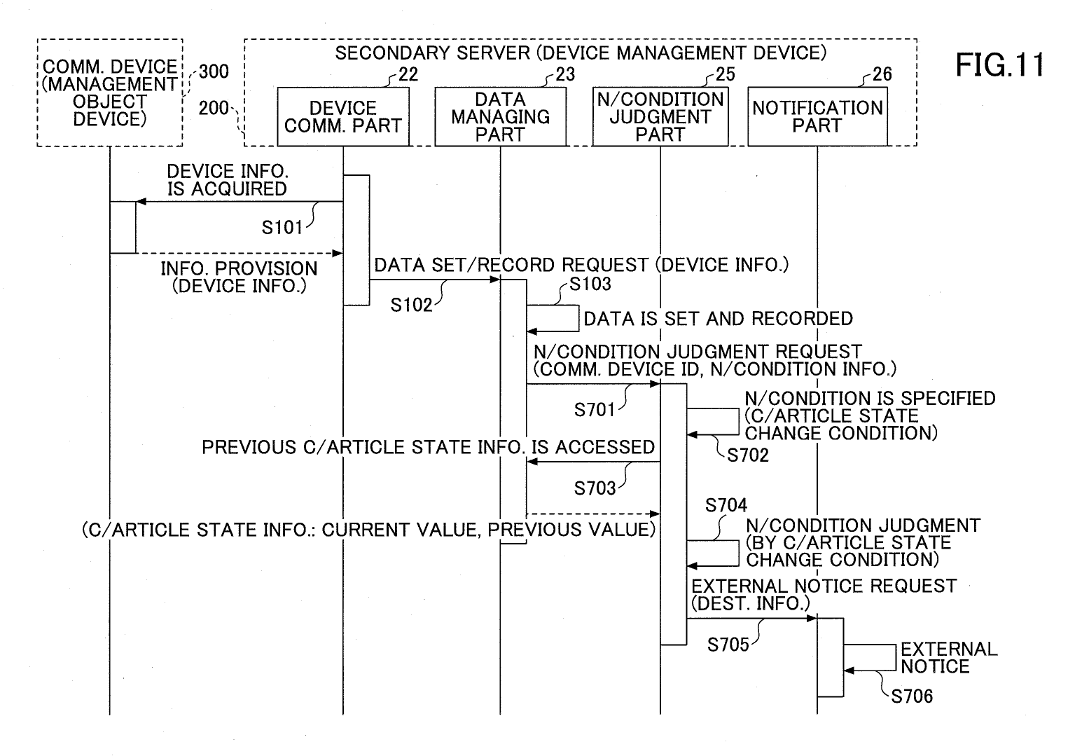

Next, FIG. 11 is a sequence diagram for explaining a process of external notification based on the notification condition in the secondary server 200 of this embodiment.

FIG. 11 shows the process when the judgment condition by a change of a consumable article state is set up as a notification condition. In the following, only the different points from the process of FIG. 10 will be described.

As shown in FIG. 11, the secondary server 200 performs the process of notification condition judgment based on the predetermined notification condition by using the notification condition judgment part 25.

For example, when “a consumable article residual quantity is changed to a near end state” due to a change of a consumable article state is set in the notification condition information 24Db as the notification condition definition information, the notification condition judging is performed as follows.

After the communication device identification information and the notification condition information 24Db are received from the data managing part 23, the notification condition judgment part 25 refers to the notification condition information 24Db and specifies that the notification condition to be applied is “a consumable article residual quantity is changed to a near end state” (step S702).

Next, the notification condition judgment part 25 refers to the device management information 24Da through the data managing part 23 based on the communication device identification information and refers to the newest state value and the previous (second newest) state value of the consumable article state information which are recorded in the device management information 24Da (step S703).

Next, the notification condition judgment part 25 determines whether the consumption article state has changed to the near end state based on the newest state value and the previous state value (step S704).

As a result, when the notification condition judgment part 25 determines that the notification condition is satisfied (when the consumption article state has changed to a near end state), the secondary server 200 passes the notification destination information to the notification part 26 and requests transmission of the notification (step S705).

The secondary server 200 transmits the notification based on the notification destination information by using the notification part 26 (step S706).

In the case of the above-described notification condition, the notification information which includes the fault information indicating that the consumable article state has changed to a near end state, and the information concerning the corresponding communication device 300 is generated and transmitted.

In the foregoing, the notification processing of the secondary server 200 has been explained. When a plurality of different notification conditions are set up, the notification process is performed for each of the notification conditions being set up. In this case, a plurality of notification condition information items 24Db will be stored in the secondary server 200, the judgment of a notification condition is performed based on each notification condition information item 24Db, and the notification processing is performed based on the judgment result.

As described above, according to the device management system 1 of this embodiment, the plurality of communication devices 300, the plurality of secondary servers 200 (device managers) which manage the communication devices 300 are connected via the plurality of internal networks N1 respectively, and the plurality of secondary servers 200 and the primary server 100 (unified management device) are connected via the external network N2, and the primary server 100 manages the communication devices 300 managed by the secondary servers 200 in a unified manner. The communication device 300 is connected to the primary server 100 via the corresponding one of the secondary servers 200. The secondary server 200 acquires the device information from the communication device 300, stores the acquired device information in the management data storage part 24 by the data managing part 23, and manages the communication device 300 by the device communication part 22. By using the primary-server communication part 21, the device information is transmitted to the primary server 100.

After the device information of the communication devices 300 is received from the secondary servers 200 by using the secondary-server communication part 11, the primary server 100 stores the received device information in the management data storage part 14 by using the data managing part 13, and manages the communication devices 300 managed by the secondary servers 200 in a unified manner.

Hence, the information processing system 1 of this embodiment can provide a device management service for the communication devices in a large-scale environment. In the device management system 1 of this embodiment, the notification condition information 14Df is stored in the primary server 100, and the notification condition information 24Db is stored in the secondary server 200 by enabling setting of different notification conditions, the processing which notifies the information of the communication device 300 outside is divided according to the kind of each notification information, and distributed processing is performed by the primary server 100 and the secondary server 200. In the device management system 1 of this embodiment, a device management service can be performed for the communication devices in a large-scale environment with good quality.

The above-described information processing method may be performed by executing the program, coded with the programming language suited to the operating environment (platform), by the processor unit (CPU) of each of the respective devices (for example, the communication device, the primary server, the secondary server, etc.) which constitute the device management system 1.

For example, in the case of the primary server 100, the above-described program may be stored in a computer-readable recording medium 103a. The above-described program may be installed in the primary server 100 through the drive device 103. The primary server 100 is provided with the interface device 107, and the above-described program may also be downloaded by using a telecommunication circuit and installed in the primary server 100.

As described in the foregoing, according to the present disclosure, a device management system is arranged so that a communication device in the device management system is connected to a unified management device via a device manager, and it is possible to provide a device management system, an information processing device, an information processing method, and a recording medium which are capable of providing a device management service in a large-scale environment.

The present disclosure is not limited to the specifically disclosed embodiments, and variations and modifications may be made without departing from the scope of the present disclosure.

The present application is based upon and claims the benefit of priority of Japanese patent application No. 2010-261770, filed on Nov. 24, 2010, and Japanese patent application No. 2011-170178, filed on Aug. 3, 2011, the contents of which are incorporated herein by reference in their entirety.

What is claimed is:

1. A device management system which manages a plurality of the communication devices, wherein the plurality of communication devices are connected to a plurality of device managers respectively, the plurality of device managers are connected to an information processing device, and each communication device is connected to the information processing device via one of the plurality of device managers,
each device manager comprising:
a first data storage part to store device information of the communication device in a predetermined storage region;
an acquisition part to acquire device information from the communication device;
a first management part to set and record the acquired device information in the first data storage part and manage the communication device; and
a transmitting part to transmit the acquired device information to the information processing device, and
the information processing device comprising:
a second data storage part to store the device information of the plurality of the communication devices in a predetermined storage region;
a reception part to receive the device information from the plurality of device managers; and
a second management part to set and record the received device information in the second data storage part and manage the plurality of the communication devices managed by the plurality of device managers in a unified manner.

2. The device management system according to claim 1, wherein the information processing device further comprises:
a notification part to transmit a notification outside; and
a notification condition judgment part to judge propriety of the notification based on a predetermined notification condition,
wherein when the device information satisfies the notification condition, the notification condition judgment part requests the notification part to transmit the notification.

3. The device management system according to claim 2, wherein the second data storage part stores device state information containing a device state value of the communication device contained in the device information, and notification condition information containing the notification condition, and
the notification condition judgment part refers to the notification condition information to specify the notification condition, refers to the device state information used for judgment based on the notification condition, and determines whether the device state information satisfies the notification condition.

4. The device management system according to claim 2, wherein the second data storage part stores consumable article state information containing a state value of a consumable article of the communication device contained in the device information, and notification condition information containing the notification condition, and
the notification condition judgment part refers to the notification condition information to specify the notification condition, refers to the consumable article state information used for judgment based on the notification condition, and determines whether the consumable article state information satisfies the notification condition.

5. The device management system according to claim 3, wherein the notification part generates notification information containing a judgment result output by the notification condition judgment part, and transmits the notification information to a notification destination based on notification destination information contained in the notification condition information.

6. The device management system according to claim 3, wherein, when device state history information containing the device state information accumulated as a device state history, and notification condition information containing a judgment condition by statistics of the device state history as a notification condition are stored in the second data storage part, the notification condition judgment part refers to the device state history information used for judgment by statistics of a device state history based on the notification condition, and determines whether the device state history information satisfies the judgment condition.

7. The device management system according to claim 6, wherein the notification part generates notification information containing statistical information of the device state history, and transmits the notification information to a notification destination based on notification condition information having notification destination information contained in the notification condition information.

8. The device management system according to claim 4, wherein, when consumable article history information containing the consumable article state information accumulated as a consumption state history, and notification condition information containing a judgment condition by statistics of the consumption state history as a notification condition are stored in the second data storage part, the notification condition judgment part refers to the consumable article history information used for judgment by statistics of a consumption state history based on the notification condition, and determines whether the consumable article history information satisfies the judgment condition.

9. The device management system according to claim 8, wherein the notification part generates notification information containing statistical information of the consumption state history, and transmits the notification information to a notification destination based on notification destination information contained in the notification condition information.

10. An information processing device for use in a device management system in which a plurality of communication devices are connected to a plurality of device managers respectively, the plurality of device managers are connected to the information processing device, and each communication device is connected to the information processing device via one of the plurality of device managers, the information processing device comprising:
a data storage part to store device information of the plurality of the communication devices in a predetermined storage region;
a reception part to receive the device information from the plurality of device managers; and
a management part to set and record the received device information in the data storage part to manage the plurality of the communication devices managed by the plurality of device managers in a unified manner.

11. The information processing device according to claim 10, further comprising:
a notification part to transmit a notification outside; and
a notification condition judgment part to judge propriety of the notification based on a predetermined notification condition,
wherein the notification condition judgment part is configured to request the notification part to transmit the notification when the device information satisfies the notification condition.

12. An information processing method for use in a device management system which manages a plurality of the communication devices, wherein the plurality of the communication devices are connected to a plurality of device managers respectively, the plurality of device managers are connected to an information processing device, and each communication device is connected to the information processing device via one of the plurality of device managers,
each device manager including a first data storage part to store device information of the communication device in a predetermined storage region, and the information processing device including a second data storage part to store the device information of the communication device in a predetermined storage region, the device management method comprising:
acquiring, by an acquisition part of each device manager, device information from the communication device;
setting and recording, by a first management part of the device manager, the acquired device information in the first data storage part to manage the communication device;
transmitting, by a transmitting part of the device manager, the acquired device information to the information processing device;
receiving, by a reception part of the information processing device, the device information from the plurality of device managers; and
setting and recording, by a second management part of the information processing device, the received device information in the second data storage part to manage the plurality of the communication devices managed by the plurality of device managers in a unified manner.

13. A non-transitory computer-readable recording medium storing a program which, when executed by a computer, causes the computer to perform the device management method according to claim 12.
